(19) United States
(12) Patent Application Publication
(10) Pub. No.: US 2026/0332508 A1
(43) Pub. Date: Oct. 22, 2026

(54) ROUTE ADVERTISEMENT AND PROGRAMMING PRIORITIZATION

(71) Applicant: Charter Communications Operating, LLC, St. Louis, MO (US)

(72) Inventors: Daniel Schatte, Monument, CO (US); Thomas Dudley, Castle Rock, CO (US)

(21) Appl. No.: 19/185,058

(22) Filed: Apr. 21, 2025

(51) Int. Cl. H04L 45/02; H04L 45/00

(52) U.S. Cl. CPC H04L 45/04; H04L 45/26

(57) ABSTRACT

At a given network unit, such as a router, obtain route advertisements for a plurality of routes from a plurality of network peers. With the given network unit, set a priority for at least a subset of routes of the plurality of routes. With the given network unit, populate a routing table of the given network unit with the plurality of routes prioritized in accordance with the priority set for the at least subset of routes of the plurality of routes. With the given network unit, route network traffic in accordance with the populated routing table.

### FIELD OF THE INVENTION

The present invention relates generally to the electrical, electronic and computer arts, and, more particularly, to communications networks and the like.

### BACKGROUND OF THE INVENTION

Border Gateway Protocol (BGP) is a non-limiting example of a protocol for exchanging routing information among autonomous systems (AS) on the Internet. BGP convergence is the process by which BGP speaking routers across a network exchange routing information to achieve a consistent view of the network topology. With many possible paths between source and destination Internet Protocol (IP) prefixes, also known as IP routes, across autonomous systems, each router must identify its own best paths to every destination. As the number of IP prefixes increases in the network, it leads to increased delays in the overall convergence time for each router.

Furthermore, BGP speaking routers maintain IP prefixes in a database table structure that is numerically sequential. During the exchange of routing information between BGP speaking routers, the advertisement and programming of IP prefixes are done sequentially. Depending on a router’s position in the network topology, certain IP prefixes are more important for supporting critical services. However, due to the advertisement and programming of IP prefixes in a sequential manner, best-effort (also known as non-critical) services may, undesirably, converge more quickly than critical services.

### SUMMARY OF THE INVENTION

Principles of the invention provide techniques for route advertisement and programming prioritization. In one aspect, an exemplary method includes the operations of obtaining, at a given network unit, route advertisements for a plurality of routes from a plurality of network peers; the given network unit setting a priority for at least a subset of routes of the plurality of routes; the given network unit populating a routing table of the given network unit with the plurality of routes prioritized in accordance with the priority set for the at least subset of routes of the plurality of routes; and the given network unit routing network traffic in accordance with the populated routing table.

In another aspect, another exemplary method includes, at a given network unit, setting a priority for a plurality of routes to be advertised; the given network unit populating a routing table of the given network unit with the plurality of routes prioritized in accordance with the priority; and the given network unit advertising the plurality of routes in accordance with the populated routing table.

In still another aspect, an exemplary network unit includes a memory; and at least one processor, coupled to the memory, and operative to: obtain route advertisements for a plurality of routes from a plurality of network peers; set a priority for at least a subset of routes of the plurality of routes; populate a routing table with the plurality of routes prioritized in accordance with the priority set for the at least subset of routes of the plurality of routes; and route network traffic in accordance with the populated routing table.

In yet another aspect, another exemplary network unit includes a memory; and at least one processor, coupled to the memory, and operative to: set a priority for a plurality of routes to be advertised; populate a routing table of the given network unit with the plurality of routes prioritized in accordance with the priority; and advertise the plurality of routes in accordance with the populated routing table.

In a further aspect, a non-transitory processor-readable medium includes processor-executable instructions which when executed by a processor cause the processor to perform the method of: obtaining, at a given network unit that includes the processor, route advertisements for a plurality of routes from a plurality of network peers; setting a priority for at least a subset of routes of the plurality of routes; populating a routing table of the given network unit with the plurality of routes prioritized in accordance with the priority set for the at least subset of routes of the plurality of routes; and routing network traffic in accordance with the populated routing table.

In still a further aspect, another non-transitory processor-readable medium includes processor-executable instructions which when executed by a processor cause the processor to perform the method of: at a given network unit that includes the processor, setting a priority for a plurality of routes to be advertised; populating a routing table of the given network unit with the plurality of routes prioritized in accordance with the priority; and advertising the plurality of routes in accordance with the populated routing table.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps (or a system wherein one or more such apparatuses are networked together, optionally with one or more other components). Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
improve the technological process of operating a communications network by providing techniques to prioritize routes for critical services in route advertisement; and
improve the technological process of operating a communications network by providing techniques to prioritize routes for critical services in route programming.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a plot showing convergence time against route prefixes, in an example of the prior art;

FIG. 2 is a plot showing convergence time against route prefixes, expected to be achieved using aspects of the invention (based on simulation using a Python script);

FIG. 3 is a workflow showing BGP route advertisement and programming as known in the prior art;

FIG. 4 is a workflow showing BGP route advertisement and programming with respect to received route prioritization, in accordance with aspects of the invention;

FIG. 5 is a workflow showing BGP route advertisement and programming with respect to advertisement prioritization, in accordance with aspects of the invention; and

FIG. 6 is a block diagram of a computer system useful in connection with one or more aspects of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present disclosure will be described herein in the context of techniques for communications networks. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

As noted, Border Gateway Protocol (BGP) convergence is the process by which BGP speaking routers across a network exchange routing information to achieve a consistent view of the network topology. With many possible paths between source and destination Internet Protocol (IP) prefixes, also known as IP routes, across autonomous systems, each router must identify its own best paths to every destination. As the number of IP prefixes increases in the network, it leads to increased delays in the overall convergence time for each router.

Furthermore, BGP speaking routers maintain IP prefixes in a database table structure that is numerically sequential. During the exchange of routing information between BGP speaking routers, the advertisement and programming of IP prefixes are done sequentially. Depending on a router’s position in the network topology, certain IP prefixes are more important for supporting critical services. However, due to the advertisement and programming of IP prefixes in a sequential manner, best-effort services may, undesirably, converge more quickly than critical services. Non-limiting examples of critical services include voice over IP (VoIP) for telephoning first responders and enterprise services for hospitals. Non-limiting examples of best-effort services include casual internet browsing, casual peer-to-peer (P2P) traffic, and the like. It will be appreciated that an ISP may provide many different services such as video, VoIP, enterprise data services, and the like.

An Internet Service Provider (ISP) typically uses many protocols in its network; one of the larger protocols for large route advertisements for end-to-end connectivity across all the public networks is BGP. Route information is exchanged, not only from route advertisements such as source and destination, but also from path attributes, to allow all routers in a path to make path selection decisions to route the traffic in the most preferred way. Routing preferences may vary based on networks and goals. There are typically large numbers of routes and paths across the public Internet; e.g., on the order of millions. When a router comes online, or a path changes, or a peer/neighbor fails, they typically must all reconverge and re-advertise the prefixes. The large number of routes means that the process is time-consuming. While these things are happening, there can be customer and/or service outages. Currently, there is no good way for an ISP to give preference to its own internal customers (or other important traffic) as opposed to outside users.

As an aside, note that a peer can also be referred to by the skilled artisan as a neighbor; thus, references to a “peer,” “neighbor,” or “peer/neighbor” are to be understood as equivalent in meaning.

As another aside, note that a cable multi-service operator (MSO) providing data services as well as entertainment services is a non-limiting example of an ISP.

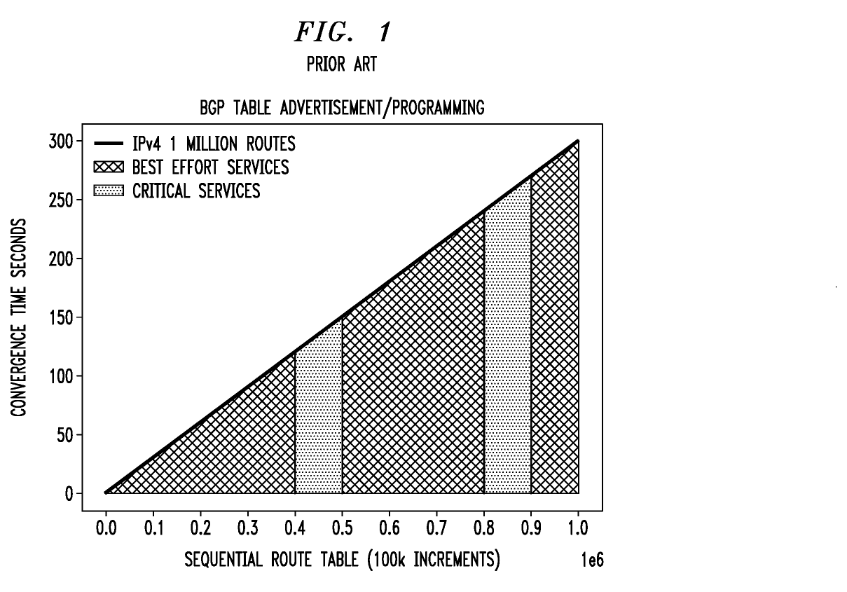

The example graph in FIG. 1 represents the advertisement and/or programming of one million IP prefixes over a 5-minute interval. Out of these one million routes, prefixes 400K-500K and 800K-900K represent critical services while all other prefixes represent best-effort services. The results indicate the suboptimal delayed convergence of critical services in the prior art.

Thus, there are typically IP addresses scattered all throughout the route range. One or more embodiments provide techniques to prioritize routes associated with customers and/or internal services, such that those routes converge first/faster/with a higher priority. FIG. 1 shows, by way of example and not limitation, one million routes in the global table along the X-axis. There may be connectivity to, e.g., dozens of network peers. All the routes must typically be advertised so that a consistent view of the overall network can be obtained. Currently, the one million routes are stored sequentially in a table structure, so that when two entities exchange routes, they will exchange 1. (“one dot”) routes, 2. (“two dot”) routes, …, all the way up to the millionth route. In FIG. 1, routes 1-400,000; 500,000-800,000; and 900,000-1,000,000 are best effort services; while routes from 400,000-500,000 and from 800,000 to 900,000 are critical services. The first “batch” of critical services from 400,000-500,000 has to wait until the routes from 0 to 400,000 are advertised, and similarly, the second “batch” of critical services has to wait for the best effort services from 500,000-800,000. The process could take on the order of an hour for a new router coming online, for example.

One or more embodiments advantageously introduce an additional route attribute to allow the prioritization of the advertisement and/or programming of IP prefixes required to support critical services over best-effort services. In one or more non-limiting exemplary embodiments, this new attribute is non-transitive (local only) to the router influencing the route prioritization and will not influence decision making processes of any other routers in the topology. One or more embodiments advantageously ensure that during initial network convergence, or failure events resulting in topology changes, the most critical services are restored as soon as possible, or suffer the least amount of service interruption.

Thus, one or more embodiments overcome the problems in the prior art using an additional route attribute. Examples are provided in the context of BGP; however, one or more embodiments are broadly applicable to a variety of route prioritization techniques. Embodiments are not limited to transmit/receive functionality; embodiments can address advertisement and/or programming prioritization as discussed elsewhere herein. In one or more embodiments, it is desirable for the ISP’s routers to be able to advertise their highest priority routes first (transmit/advertise) and also to decide what routes that are advertised to the routers are more or less critical (programming of routes received from a peer/neighbor). In one or more embodiments, the new attribute is non-transitive (locally significant), and is not exchanged between peers/neighbors. In one or more embodiments, it is not desirable for external/untrusted peer/neighbor routers (e.g., routers from entities outside the ISP) to be able to dictate the ISP’s priorities. On the other hand, influence from trusted peers owned, operated, or otherwise controlled by the ISP or other trusted party(ies) is acceptable. One or more embodiments can be used for both initial convergence and failure/re-convergence scenarios.

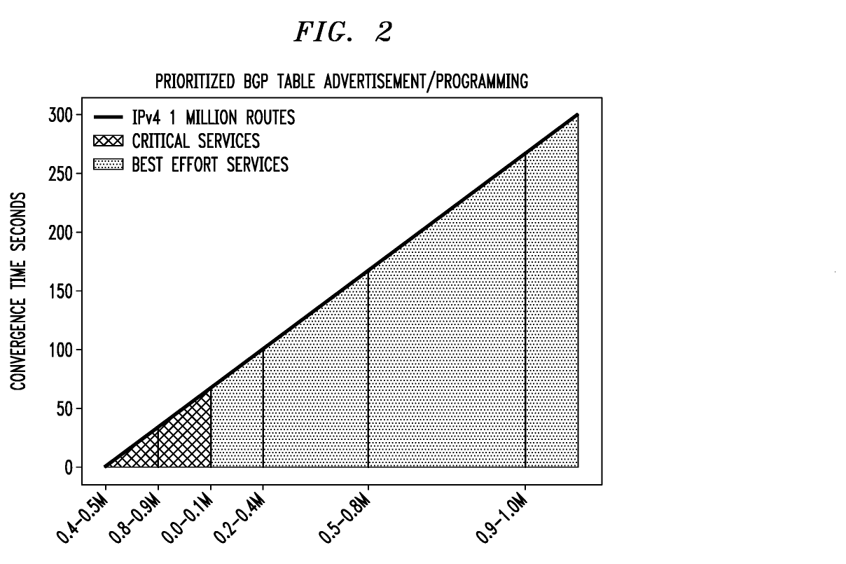

FIG. 2, which is based on simulation using a Python script, represents the same advertisement and/or programming of one million IP prefixes over a 5-minute interval; however, in accordance with aspects of the invention, now the critical services prefixes 400K-500K and 800K-900K are advertised and/or programmed first, followed by the remaining best-effort prefixes. The results present an example of the optimized convergence of critical services. As will be appreciated from FIG. 2, which depicts a re-ordering of the graph of FIG. 1 in accordance with aspects of the invention, it is desired to program the 400,000-500,000 range first, and then the 800,000-900,000 range. The 800,000-900,000 range could have been slotted first if desired. The best effort services are then handled after the 400,000-500,000 and 800,000-900,000 ranges.

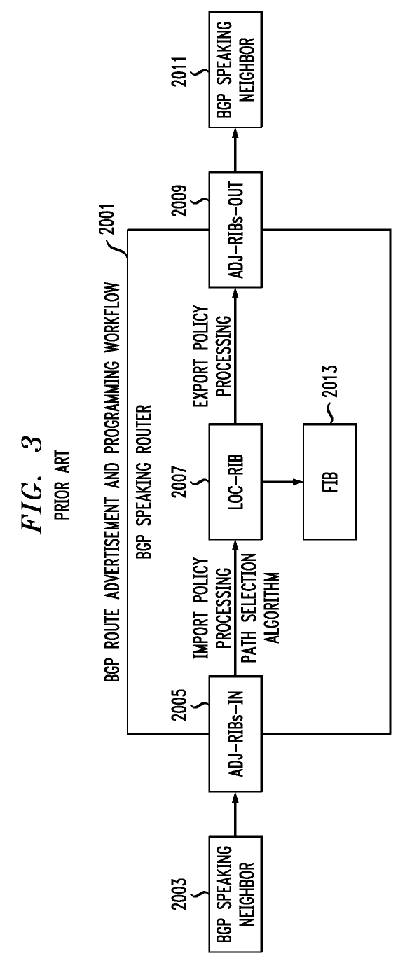

Referring to FIG. 3, consider some of the table structures that are common across many different router vendors/types. Generally, industry-standard terminology is employed herein; some vendors may use different terminology.

Consider the LOC-RIB data structure 2007 (RIB = Routing Information Base). This data structure stores routing information of each IP Prefix learned from various protocols, along with all the available route attributes, including the destination IP addresses and the next-hop addresses for reaching those destinations for each individual IP prefix. The LOC-RIB data structure 2007 can contain many available paths to reach each destination IP prefix, and is used to determine the best path for forwarding traffic. In one or more embodiments, the LOC-RIB data structure 2007 includes a new criticality attribute in accordance with aspects of the invention. The LOC-RIB data structure 2007 is local to the router; it includes all the different routes learned from all the different peers, protocols, and the like. Note that “routes” and “prefixes” are used somewhat interchangeably herein. In one or more embodiments, the LOC-RIB data structure 2007 includes route and path attributes for routes that can be used to send traffic to various destinations. The new criticality attribute introduced herein does not exist in the BGP or other current protocol stacks; it is a novel route attribute that is local to the ISP’s routers and specifies the level of priority. See the BGP Route Prioritization Attribute discussion further below for a non-limiting example of the new criticality attribute in the non-limiting exemplary context of BGP. It is worth noting that a router in the ISP’s network can have, for example, two or three dozen (or more) peers/BGP neighbors. A route reflector can have, for example, 100 or more peers/BGP neighbors.

ADJ-RIBs-IN 2005 is a set of data structures that store routing information received from each BGP speaking peer/neighbor 2003. Local route import policies are applied, that can filter routes or alter received route attributes. ADJ-RIBs-IN is more specific than RIB. It is a data structure that stores routing information received from each individual peer. For example, a router in the ISP’s network may have two or three dozen (or more) peers/BGP neighbors. A route reflector may have 100 or more peers/BGP neighbors. ADJ-RIBs-IN is an ingress storage for all the routes being learned from the neighbors.

LOC-RIB 2007 is a data structure that stores routing information of the best paths for each IP prefix that has been selected from the ADJ-RIB-IN data structures after the algorithms for best path selection processes have been applied. Depending on implementation, the LOC-RIB can contain more than one best path, additional-paths, or multipaths. For example, there may be ten neighbors advertising routes to a given network unit (as discussed further below), and based on their route attributes, their metrics, their local preferences, AS (autonomous system) path, and the like (i.e., all different types of route attributes that already exist in BGP), use a path selection process to select the best path and store it in the local RIB. ADJ-RIBs-IN is analogous to pre-processing of received routes. LOC-RIB is analogous to post-processing “this is my best path and what I will store for my routing decisions.”

ADJ-RIBs-OUT 2009 is a set of data structures that store routing information advertised to each BGP speaking neighbor. Local route export policies are applied that can filter routes or alter advertised route attributes. ADJ-RIBs-OUT is essentially the opposite of ADJ-RIBs-IN. It is a per-peer table for all neighbors for routes that it is desired to advertise. Based on that table, export policies can be applied to manipulate some of the attributes when advertising them to a neighbor. Since the new attribute in accordance with one or more embodiments is non-transitive, it is not contemplated that it will be advertised to a peer. Note that ADJ-RIBs-IN and ADJ-RIBs-OUT are per-peer/neighbor.

Forwarding Information Base (FIB) 2013 is a data structure that stores the active routing entries based on the best path selection processes from the LOC-RIB 2007. The FIB is ultimately used for packet forwarding and programs the best paths to reach each IP prefix’s destination network, next-hop address, and the interface through which traffic should be forwarded. RIB is a control-plane functionality; the unit has learned all the routes, has selected the best route, and now it is appropriate to instruct the hardware/ASICs how to forward traffic to these routes. Based on the local RIB, and the selection of all the best paths, now program into the FIB IP the prefixes for the destination, next hop address, and the interface from which it is desired to send the traffic. Stated in another way, RIB is referenced here as the control-plane functionality, which is then used to program the FIB data-plane functionality.

The example diagram of FIG. 3 depicts an exemplary prior-art workflow 2001 of route advertisements being received from a BGP speaking peer/neighbor 2003 into the ADJ-RIBs-IN 2005, Import Policy processing, best-path path selection algorithm processing, programming into the LOC-RIB 2007, programming into FIB 2013, and then advertised to other BGP speaking peers/neighbors 2011 by applying export policy processing, programming into the ADJ-RIBs-OUT 2009, and finally advertising to each BGP speaking peer/neighbor 2011. Still referring to the workflow 2001 of FIG. 3, there can be one or more BGP speaking peers/neighbors 2003. They are advertising all their routes in the per-neighbor ADJ-RIBs-IN 2005. Import policy processing is carried out in case it is desired to manipulate any of the attributes received from the neighbors. A path selection algorithm is then applied and the paths are programmed into the LOC-RIB 2007. Once the local route is programmed, push the results down into the Forwarding Information Base (FIB) 2013. Essentially the same process is carried out in the egress direction. Export policy processing is carried out on the LOC-RIB 2007 and the results placed in ADJ-RIBs-OUT 2009, for advertisement to one or more BGP speaking peers/neighbors 2011. Note that the BGP speaking neighbor on the left 2003and the BGP speaking neighbor on the right 2011 have different numbers. Generally, they can both be the same neighbor(s) or different neighbor(s). The intent is to provide a reference for both import and export (receive and transmit) functionality. Note that a peer/neighbor can be any suitable type of network unit – routers and route reflector are non-limiting examples.

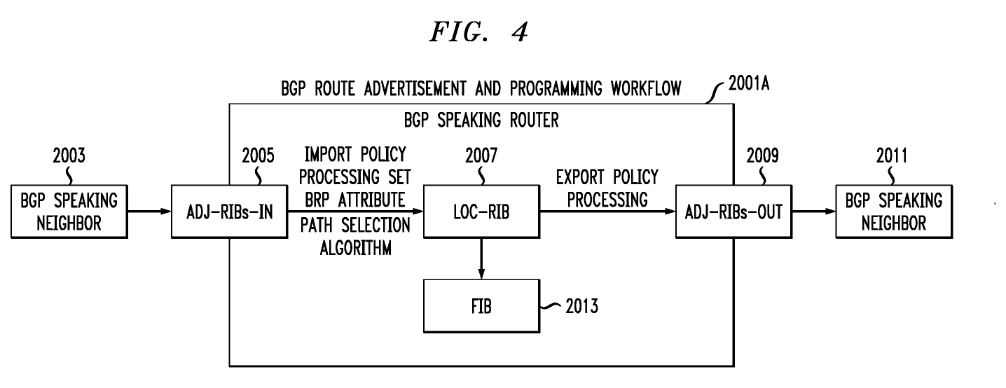

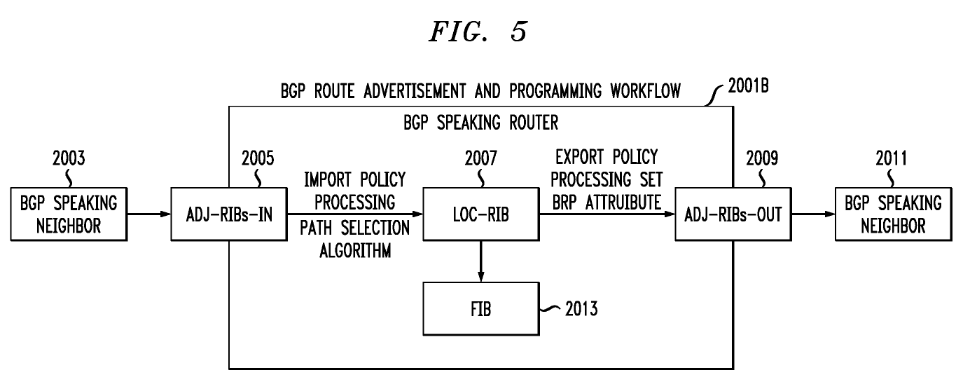

Various exemplary components of one or more exemplary embodiments of the invention will now be discussed with reference to FIGS. 4 and 5.

BGP Route Prioritization Attribute: one or more embodiments introduce a new non-transitive route prioritization attribute that can be leveraged for both advertised route scheduling prioritization and received route programming prioritization for both RIB and FIB. In one or more embodiments, this attribute can leverage any type of prioritization methodologies including, but not limited to, a high/medium/low queue scale or a weighted 0-n numerical value queue scale. That is to say, the BGP Route Prioritization Attribute can be, but is not necessarily, a “high, medium, and low” scale like quality of service (QoS) and also can be, but is not necessarily, a numerical value from 0 to n, such as 1, 4, 5, or 10 (“n” could be 10, 100, etc.). In one or more embodiments, all that is required is the ability to flag a route with an attribute that allows for manipulation of the programming of that route based on its importance or criticality to the ISP’s network and/or other relevant factors. The novel attribute in accordance with aspects of the invention is not currently present, attached, or stored in any of the existing databases. It is to be emphasized that embodiments can be applied to other protocols/route types in addition to BGP. One or more embodiments permit prioritizing routes that are advertised and/or how received routes are programmed. Some current platforms have a high/medium/low queue for QoS statistics, where a certain packet type can be prioritized for critical network services ahead of best effort traffic. There can be different groups of critical routes besides the example values given; e.g., 0-10, 50-60, and the like. The examples given herein are all non-limiting examples of prioritization techniques. It should be noted that the term “queue” is not necessarily meant to represent a specific dedicated or shared buffer space or memory allocation, only a scheduling methodology of how higher priority IP prefixes are processed before lower priority IP prefixes.

BGP Route Prioritization Attribute Match Conditions: in one or more embodiments, the new route attribute leverages existing BGP policy match conditions including, but not limited to, AS-path, community, internal/external, local-preference, metric, origin, prefix-lists, protocol, or any other route attribute. Consider now the application of BGP Route Prioritization Attribute Match Conditions, according to aspects of the invention, it being understood that embodiments of the invention are not limited to any specific code/ASIC/vendor platform implementation. The aforementioned attributes are attributes of a route, some of which are transitive and some of which are not. They can be manipulated in an import/export policy to shift traffic flows, which route(s) are programmed, which route(s) are not programmed, and the like. One or more embodiments employ industry-standard technologies such as BGP, but this is a non-limiting example. In one or more embodiments, anything that can be matched on in policy, can have the new BGP Route Prioritization Attribute, examples of which are disclosed herein, implemented or attached. BGP policy matching (more generally, route policy matching) is a known technique in BGP and other route protocols; non-limiting examples of other protocols include Open Shortest Path First (OSPF), Intermediate System to Intermediate System (IS-IS), Protocol Independent Multicast (PIM), Label Distribution Protocol (LDP), Multiple Protocol Label Switching (MPLS), and the like. One or more embodiments are applicable to any methodology that can be used to manipulate attributes of a route.

Further regarding matching, in the import policy, it is possible to match on all different types of attributes that influence routing behavior. In one or more embodiments, any of those existing attributes that can be matched on in policy will have the ability to attach the new BGP Route Prioritization Attribute to them to affect the prioritization. As would be appreciated by the skilled artisan, the autonomous system (AS) path, community metric, and the like are non-limiting examples of route attributes that can be attached to every prefix that is advertised.

BGP Received Route Prioritization: Referring to FIG. 4, as route advertisements are received in the form of BGP Update messages from BGP speaking neighbors into the ADJ-RIBs-IN, the import policy match conditions will set the BGP Route Prioritization Attribute for each route. Higher priority IP prefixes will be processed and programmed into the LOC-RIB and FIB before lower-priority IP prefixes. Note the import policy processing, which sets the route prioritization attribute (e.g., BGP Route Prioritization Attribute “BRP”) before programming into LOC-RIB 2007. This will inform the unit which routes to prioritize and program in LOC-RIB first. The remainder of FIG. 4 is generally similar to the workflow of FIG. 3. Note that the workflow in FIG. 4 is designated as 2001A and the workflow in FIG. 5 is designated as 2001B, it being understood that the workflows of FIGS. 4 and 5 can be combined in some cases.

BGP Advertisement Prioritization: Referring to FIG. 5, in one or more embodiments, the LOC-RIB 2007 should already have a BGP Route Prioritization Attribute set for each route; however, should a use case exist to alter the advertisement priority toward BGP speaking neighbor(s), the Export policy can also contain a match condition to set the BGP Route Prioritization Attribute for each route to be sent to the ADJ-RIBs-OUT for each BGP speaking neighbor.

Still referring to FIG. 5, BGP Advertisement Prioritization essentially does the same thing as the BGP Received Route Prioritization in FIG. 4 in the opposite direction. LOC-RIB 2007 already has the BGP prioritization set for each route. However, if it was desired to alter it, it could also be altered with an export policy, like any other BGP attribute. This permits prioritizing the order in which the routes are advertised by ADJ-RIBs-OUT 2009 to each individual peer/neighbor 2011. Again, FIG. 4 depicts ingress while FIG. 5 depicts egress. In one or more embodiments, on the ingress/inbound side, ADJ-RIBs-IN 2005 is set to prioritize as it learns routes from one or many peers/neighbors 2003. In one or more embodiments, it is desired to prioritize routes that are deemed critical, and those routes are programmed in LOC-RIB first, before they are programmed into FIB. That is to say, first program RIB; RIB then programs FIB. Now continuing, typically, priorities are set on ingress and so should already be set; other embodiments can also have local routes that are generated locally and advertise rather than learning. So, on ingress, route prioritization can be set on import or locally. In one or more embodiments, on egress, the prioritization attribute will have typically been set on the local router. However, should the need arise, and a different prioritization was desired on ingress versus egress, the exemplary inventive attribute could also be manipulated on egress. So the exemplary inventive attribute could be set on ingress, locally, or on egress.

It is worth noting that in general, route prioritization information can reside in a table on the router, in a data structure external to the router with a high-speed connection to the router, or partially on the router and partially remote. Further, the table can be a single unified table or can include separate data structures as set forth in the non-limiting examples herein.

It is worth noting that, as would be appreciated by the skilled artisan, BGP communities are attribute tags that can be applied to incoming or outgoing prefixes to achieve some common goal. BGP communities are not employed directly for prioritization; they provide a way to identify and match on routes, and are transitive. In one or more non-limiting exemplary embodiments, the BGP Route Prioritization Attribute is non-transitive (local only) and is employed for prioritization.

Note again that non-limiting examples have been presented herein in the context of Borger Gateway Protocol (BGP). However, as would be appreciated by the skilled artisan given the teachings herein, many other protocols could be used, including but not limited to: Open Shortest Path First (OSPF), Intermediate System to Intermediate System (IS-IS), Protocol Independent Multicast (PIM), Label Distribution Protocol (LDP), Multiple Protocol Label Switching (MPLS). Further, many different types of routes could be used, including but not limited to: IPv4 Unicast, IPv6 Unicast, IPv4 Labeled-Unicast, IPv6 Labeled-Unicast, IPv4 Multicast, IPv6 Multicast. Even further, many different types of attributes could be used, including but not limited to: Next-hop, Weight, Local Preference, Originator, AS Path Length, Origin, Multiple Exit Discriminator (MED), Metric, Cost, eBGP, iBGP, IGP, EGP, Cluster-ID, Cluster Length, Router-ID, and Path-ID.

Given the discussion thus far, it will be appreciated that, in general terms, an exemplary method, according to an aspect of the invention, includes the step of obtaining, at a given network unit 2001A, 2001B, route advertisements for a plurality of routes from a plurality of network peers 2003. A further step includes the given network unit setting a priority for at least a subset of routes of the plurality of routes (regarding “at least a subset,” in a non-limiting example, best efforts traffic could be left alone). Still a further step includes the given network unit populating a routing table (in a non-limiting example, 2007) of the given network unit with the plurality of routes prioritized in accordance with the priority set for the at least subset of routes of the plurality of routes. Yet a further step includes the given network unit routing network traffic in accordance with the populated routing table.

In a non-limiting example, the given network unit includes a router.

One or more embodiments further include the given network unit advertising the plurality of routes in accordance with the populated routing table (in a non-limiting example, 2009). Note that a “populated routing table” could, by way of example and not limitation, include the sum of all, or any subset of, the individual BGP tables depicted (or analogous tables in other protocols).

Some embodiments further include the given network unit modifying the populated routing table to reprioritize at least a portion of the routes; and the given network unit advertising the plurality of routes (e.g., to neighbors 2011) in accordance with the reprioritized populated routing table.

In one or more non-limiting exemplary embodiments, the setting of the priority comprises setting a non-transitive border gateway protocol (BGP) route prioritization attribute. In one or more embodiments, this attribute can leverage any type of prioritization methodologies including, but not limited to, a high/medium/low queue scale or a weighted 0-n numerical value queue scale. As would be apparent to the skilled artisan given the teachings herein, matching, comparison statements, or the like can be used to prioritize accordingly. For example, in a very simple approach, critical/priority routes are done first and best efforts routes are done after that in a conventional manner. When the high/medium/low queue scale is used, high is processed before medium which is processed before low. When the weighted 0-n numerical value queue scale is used, whichever is treated as highest is done first, and so on – if the scale is 0-5 and 0 is agreed upon as highest priority, process in order 0, 1, 2, 3, 4, 5; if the scale is 0-5 and 5 is agreed upon as highest priority, process in order 5, 4, 3, 2, 1.

In one or more embodiments, this attribute is non-transitive and locally significant to avoid abuse of prioritization by an untrusted peer/neighbor. For example, there is an external peer from another ISP (e.g., another MSO). It is not necessarily appropriate to permit such an external, untrusted peer to influence prioritization of routes advertised by that peer (e.g., to be able to prioritize its routes over a hospital or first responder or the like). In one or more embodiments, a network unit receives routes, programs the most critical ones first, and make a local decision which ones to advertise first to (in-network) peers.

In the non-limiting example case of BGP, the step of obtaining the route advertisements includes populating an ADJ-RIBs-IN table 2005; the step of setting the priority for the at least subset of routes includes carrying out import policy processing to set the non-transitive border gateway protocol (BGP) route prioritization attribute via matching; the step of populating the routing table includes populating a LOC-RIB table 2007; and the step of routing the network traffic in accordance with the populated routing table includes routing in accordance with the LOC-RIB table. For example, in the BGP case, route per RIB 2007 and forward based on FIB 2013. Again, note that a “populated routing table” could, by way of example and not limitation, include the sum of all, or any subset of, the individual BGP tables depicted.

Further regarding matching, in the non-limiting example of the BGP case, apply import policy processing to set the BRP attribute via matching. It is possible to match on any route attribute or condition, prefix list, community, AS path, or the like.

In the non-limiting example case of BGP, some embodiments further include the given network unit advertising the plurality of routes in accordance with the populated routing table, wherein the populated routing table includes an ADJ-RIBs-OUT table 2009.

In the non-limiting example case of BGP, some embodiments further include the given network unit modifying the populated routing table, via export policy processing (e.g., including matching), to reprioritize at least a portion of the routes; and the given network unit advertising the plurality of routes (e.g., to neighbors 2011) in accordance with the reprioritized populated routing table, wherein the reprioritized populated routing table includes an ADJ-RIBs-OUT table 2009. For example, in the non-limiting BGP case, advertisement is in accordance with ADJ-RIBs-OUT 2009, which is modified from LOC-RIB 2007 by the export policy processing.

In another aspect, consider that some next generation routers may have hundreds of interfaces on them. It is possible, for example, to be advertising locally connected interfaces that are routes that do not get learned via a peer; they are locally originated on this router (or other network unit). It is desired to advertise the most critical ones to upstream peers before advertising a plurality of best efforts routes.

In accordance with this aspect, an exemplary method includes, at a given network unit 2001B, setting a priority for a plurality of routes to be advertised; the given network unit populating a routing table of the given network unit with the plurality of routes prioritized in accordance with the priority; and the given network unit advertising the plurality of routes in accordance with the populated routing table (e.g., ADJ-RIBs-OUT 2009). In some cases, at least some of the advertised routes are locally generated on the given network unit. In the non-limiting example of BGP, the setting of the priority includes setting a non-transitive border gateway protocol (BGP) route prioritization attribute.

In another aspect, a non-transitory processor-readable medium includes processor-executable instructions which when executed by a processor cause the processor to perform or otherwise facilitate any one, some, or all of the method steps disclosed herein. The given network unit, as discussed herein, includes the processor.

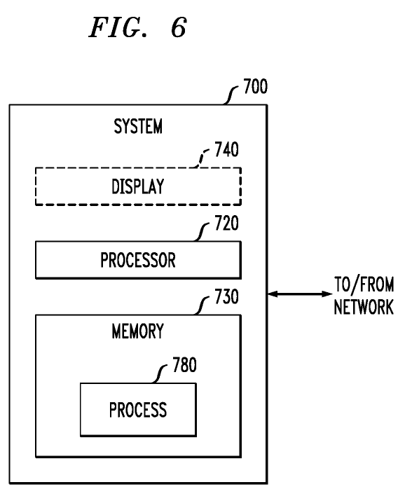

In still another aspect, a network unit includes (see. e.g., FIG. 6) a memory; and at least one processor, coupled to the memory, and operative to carry out or otherwise facilitate any one, some, or all of the method steps disclosed herein. The route table(s) can be stored in the memory of the network unit or externally, as discussed elsewhere herein.

### System and Article of Manufacture Details

As noted, in a non-limiting example, the network unit can be a router. As would be appreciated by the skilled artisan, a router functions like a small computer and therefore typically contains both a processor (CPU) and memory (RAM and flash memory) to handle network traffic and store its operating system and configurations. Accordingly, a description of FIG. 6 is provided below, it being understood that a router may not have all features of a traditional desktop computer (e.g., display can be omitted).

The invention can employ hardware aspects, software aspects, or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

FIG. 6 is a block diagram of at least a portion of an exemplary system 700 that can be configured to implement at least some aspects of the invention, and is representative, for example, of one or more of the routers or other network units, peers/neighbors, apparatuses, servers, or modules shown in the figures. As shown in FIG. 6, memory 730 configures the processor 720 to implement one or more methods, steps, and functions (collectively, shown as process 780 in FIG. 6). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
obtaining, at a given network unit, route advertisements for a plurality of routes from a plurality of network peers;
the given network unit setting a priority for at least a subset of routes of the plurality of routes;
the given network unit populating a routing table of the given network unit with the plurality of routes prioritized in accordance with the priority set for the at least subset of routes of the plurality of routes; and
the given network unit routing network traffic in accordance with the populated routing table.

2. The method of claim 1, further comprising the given network unit advertising the plurality of routes in accordance with the populated routing table.

3. The method of claim 1, further comprising:
the given network unit modifying the populated routing table to reprioritize at least a portion of the routes; and
the given network unit advertising the plurality of routes in accordance with the reprioritized populated routing table.

4. The method of claim 1, wherein the setting of the priority comprises setting a non-transitive border gateway protocol (BGP) route prioritization attribute.

5. The method of claim 4, wherein:
the step of obtaining the route advertisements includes populating an ADJ-RIBs-IN table;
the step of setting the priority for the at least subset of routes includes carrying out import policy processing to set the non-transitive border gateway protocol (BGP) route prioritization attribute via matching;
the step of populating the routing table includes populating a LOC-RIB table; and
the step of routing the network traffic in accordance with the populated routing table includes routing in accordance with the LOC-RIB table.

6. The method of claim 5, further comprising the given network unit advertising the plurality of routes in accordance with the populated routing table, wherein the populated routing table includes an ADJ-RIBs-OUT table.

7. The method of claim 5, further comprising:
the given network unit modifying the populated routing table, via export policy processing, to reprioritize at least a portion of the routes; and
the given network unit advertising the plurality of routes in accordance with the reprioritized populated routing table, wherein the reprioritized populated routing table includes an ADJ-RIBs-OUT table.

8. The method of claim 1, wherein the given network unit comprises a router.

9. A method comprising:
at a given network unit, setting a priority for a plurality of routes to be advertised;
the given network unit populating a routing table of the given network unit with the plurality of routes prioritized in accordance with the priority; and
the given network unit advertising the plurality of routes in accordance with the populated routing table.

10. The method of claim 9, wherein at least some of the advertised routes are locally generated on the given network unit.

11. The method of claim 9, wherein the setting of the priority comprises setting a non-transitive border gateway protocol (BGP) route prioritization attribute.

12. A network unit comprising:
a memory; and
at least one processor, coupled to the memory, and operative to:
obtain route advertisements for a plurality of routes from a plurality of network peers;
set a priority for at least a subset of routes of the plurality of routes;
populate a routing table with the plurality of routes prioritized in accordance with the priority set for the at least subset of routes of the plurality of routes; and
route network traffic in accordance with the populated routing table.

13. The network unit of claim 12, wherein the at least one processor is further operative to advertise the plurality of routes in accordance with the populated routing table.

14. The network unit of claim 12, wherein the at least one processor is further operative to:
modify the populated routing table to reprioritize at least a portion of the routes; and
advertise the plurality of routes in accordance with the reprioritized populated routing table.

15. The network unit of claim 12, wherein the at least one processor is operative to set the priority by setting a non-transitive border gateway protocol (BGP) route prioritization attribute.

16. The network unit of claim 15, wherein:
the at least one processor is operative to obtain the route advertisements by populating an ADJ-RIBs-IN table;
the at least one processor is operative to set the priority for the at least subset of routes by carrying out import policy processing to set the non-transitive border gateway protocol (BGP) route prioritization attribute via matching;
the at least one processor is operative to populate the routing table by populating a LOC-RIB table; and
the at least one processor is operative to route the network traffic in accordance with the populated routing table by routing in accordance with the LOC-RIB table.

17. The network unit of claim 16, wherein the at least one processor is further operative to advertise the plurality of routes in accordance with the populated routing table, wherein the populated routing table includes an ADJ-RIBs-OUT table.

18. The network unit of claim 16, wherein the at least one processor is further operative to:
modify the populated routing table, via export policy processing, to reprioritize at least a portion of the routes; and
advertise the plurality of routes in accordance with the reprioritized populated routing table, wherein the reprioritized populated routing table includes an ADJ-RIBs-OUT table.

19. A network unit comprising:
a memory; and
at least one processor, coupled to the memory, and operative to:
set a priority for a plurality of routes to be advertised;
populate a routing table of the given network unit with the plurality of routes prioritized in accordance with the priority; and
advertise the plurality of routes in accordance with the populated routing table.

20. The network unit of claim 19, wherein the at least one processor is further operative to locally generate at least some of the advertised routes.

21. The network unit of claim 19, wherein the at least one processor is operative to set the priority by setting a non-transitive border gateway protocol (BGP) route prioritization attribute.

22. A non-transitory processor-readable medium comprising processor-executable instructions which when executed by a processor cause the processor to perform the method of:
obtaining, at a given network unit that includes the processor, route advertisements for a plurality of routes from a plurality of network peers;
setting a priority for at least a subset of routes of the plurality of routes;
populating a routing table of the given network unit with the plurality of routes prioritized in accordance with the priority set for the at least subset of routes of the plurality of routes; and
routing network traffic in accordance with the populated routing table.

23. A non-transitory processor-readable medium comprising processor-executable instructions which when executed by a processor cause the processor to perform the method of:
at a given network unit that includes the processor, setting a priority for a plurality of routes to be advertised;
populating a routing table of the given network unit with the plurality of routes prioritized in accordance with the priority; and
advertising the plurality of routes in accordance with the populated routing table.
